(19) United States
(12) Patent Application Publication
(10) Pub. No.: US 2006/0253568 A1
(43) Pub. Date: Nov. 9, 2006

(54) Method for digital content transmission

(76) Inventor: Jeng-Tay Lin, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/124,049

(22) Filed: May 9, 2005

(51) Int. Cl. G06F 15/173

(52) U.S. Cl. 709/224

(57) ABSTRACT

A method for digital content transmission is adopted in a digital content device. The method is used to determine the connection status between the device and a digital content server by monitoring the usage status of a memory device thereof. The memory usage is monitored, and wireless communication module therein is activated or deactivated to reduce power usage. The preferred embodiment of the present invention activates a wireless communication module in the beginning, then transmits a receive-data signal, and monitors the usage status of a memory device to determine whether to transmit data. After that, a stop-receive-data signal is transmitted, the wireless communication module is deactivated, and the transmission is turned off. While the data in the memory device is consumed, the usage status is monitored to determine whether to re-activate the wireless communication module.

### BACKGROUND OF THE INVENTION

1. Field of Invention

A method for digital content transmission is adopted in a digital content device, and more particularly to determine whether to proceed in transmitting data by monitoring the usage status of a memory device so as to save power.

2. Description of Related Art

A storage device such as a flash memory, a hard disk or the like is often used to store the digital audio/video files in a regular portable digital device. The user can enjoy audio/video entertainment anywhere with the portable digital device. Furthermore, a buffer memory with low memory capacity disposed in the digital device is used to store the temporary files in streaming format downloaded from a server. The server provides the audio/video content with wireless connection to the digital device.

Power consumption in portable digital devices is their biggest problem. In particular, the wireless module therein, when downloading data, is the critical cause of excessive power consumption. U.S. Pat. No. 5,539,925 discloses a radio system with power-saving feature for mobile stations. The mobile radio station switches off its unnecessary power-consuming portions, such as a radio receiver, during transmission breaks.

Another power-saving method applied in a portable device is described in U.S. Pat. No. 6,463,307, which discloses a method and apparatus for power conservation in a mobile terminal with established connections. The mobile terminal hibernating in a power-saving mode will listen for paging messages from a base station periodically. If no paging messages are present, the mobile terminal continues hibernating, thus conserving battery power by not communicating with the base station. Nevertheless, in the low power-consuming mode, the mobile terminal still listens for the paging messages from the base station. If paging messages are present, then the mobile terminal awakens, changes to the awake state, then acknowledges the paging message, and begins receiving data from the base station.

In view of the background arts mentioned above, the mobile device often determines a specific power-saving mode by detecting whether there are paging messages or not. The effect is finite since the detection signals between the mobile device and the station still exist in the power-saving mode.

### SUMMARY OF THE DISCLOSURE

A method for transmitting digital content is disclosed. A connection status between a digital content device and a digital content server is determined by monitoring the usage status of a memory device therein. The wireless communication module in the device is switched on or off based on memory usage so as to reduce the power consumption of the digital content device of the present invention.

In preferred embodiment, the method for transmitting digital content disclosed in the present invention, the usage status of the memory device is monitored first, and then a wireless communication module is activated so as to transmit the digital content thereafter. Again, the device monitors the usage status of the memory device and determines whether the wireless communication module is deactivated or not. The wireless communication module is then deactivated if data size in the memory reaches a given ratio so as to turn off transmission to the server.

In the other preferred embodiment, the method is to activate a wireless communication module after turning power on in the beginning. Then the device transmits a receive-data signal to a server, and proceeds to transmit or receive data. Meanwhile, the device monitors the usage status of a memory device therein so as to determine whether to transmit data or not. When the received data in memory reaches a second given ratio, a stop-receive-data signal is transmitted to the server, and the wireless communication module is deactivated so as to terminate the transmission. The transmission is turned off, while the data in the memory device is consumed. Then, the processor determines whether to re-activate the wireless communication module after monitoring the memory usage status.

The digital content device of the present invention uses a processor to monitor the memory usage status. If the streaming data size of the memory device is less than or equal to a first given ratio, the wireless communication module is activated. If the data size of the memory device reaches a second given ratio, the wireless communication module is deactivated.

### BRIEF DESCRIPTION OF DRAWINGS

The present invention will be readily understood by the following detailed description in conjunction accompanying drawings, in which:

FIG. 1A is a schematic diagram of connection between a server and a digital content device of the present invention;

FIG. 1B is a block diagram of the digital content device of the present invention;

FIG. 2 is a flowchart illustrating the method for transmitting the digital content of the preferred embodiment of the present invention;

FIG. 3 is a flowchart illustrating the method for transmitting the digital content of the preferred embodiment of the present invention; and

FIG. 4 is a flowchart illustrating the method for transmitting the digital content of the preferred embodiment of the present invention.

### DETAILED DESCRIPTION OF THE PREFERRED EMBODIMENTS

To allow the Examiner to understand the technology, means and functions adopted in the present invention further, reference is made to the following detailed description and attached drawings. The Examiner shall readily understand the invention deeply and concretely from the purpose, characteristics and specification of the present invention. Nevertheless, the present invention is not limited to the attached drawings and embodiments in following description.

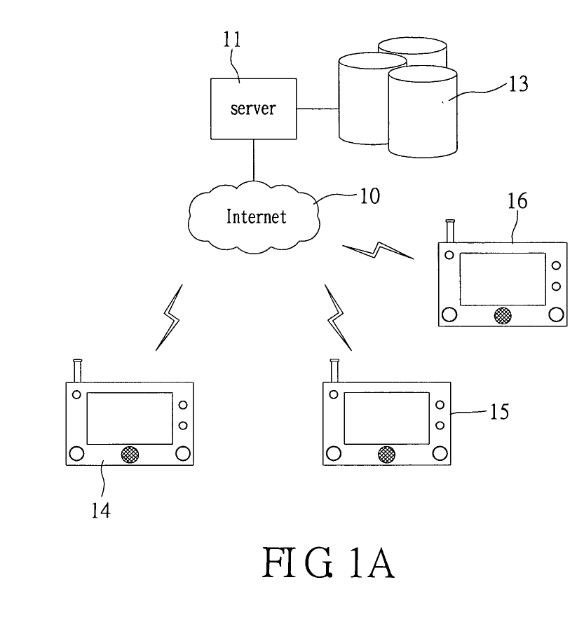

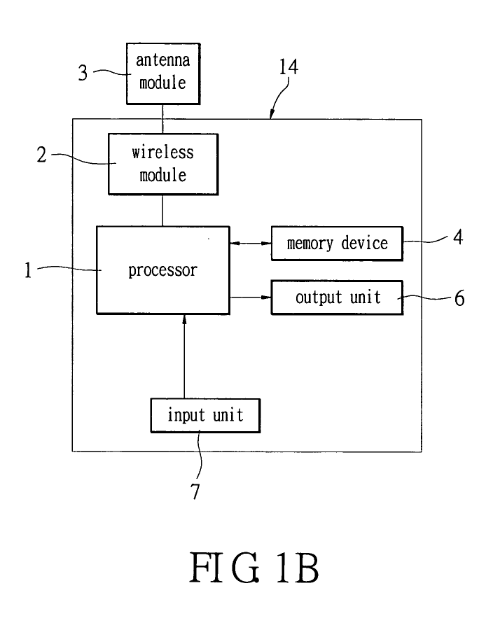

FIG. 1A shows a schematic diagram of the connection between a remote server 11 and a digital content devices 14, 15, 16 using the method for transmitting digital content of the present invention. The mentioned remote server 11 is provided by a digital content provider, which connects to a digital content database 13 storing audio/video digital content. The provided content includes compressed musical data, such as MP3, and video, such as MPEG2, MPEG4 or the like, and other digital data, such as pictures, electronic book (ebook), and software. The remote server 11 connects to Internet 10, and a user can download the digital content stored in the server 11 using the portable digital content devices 14, 15, 16 shown in diagram.

In preferred embodiment of the present invention, the digital content devices 14, 15, 16 connect to Internet 10 over wireless communication and proceed to download the digital content from a database 13 in a streaming format. Finally, after the streaming packets and digital signals are processed by a processor 1 built in the digital content devices 14, 15, 16, the output device, such as a displayer, speaker or the like, disposed in the device is utilized. Nevertheless, the server 11 shown in the diagram can be various embodiments; for example, the digital content originally from the server 11 can be provided by a plurality of servers connecting to Internet 10 as well.

The aforementioned streaming method is adapted for transmission over Internet. The embodiment of the present invention transmits high-quality compressed audio/video files and reproduces the optimized content over a bandwidth-limited network.

A preferred embodiment of the digital content device of the present invention is shown in FIG. 1B. The device at least comprises a control chip, such as a processor 1 shown in diagram, controlling the inside input/output signals, a wireless communication module 2 coupling with the processor 1, and also an antenna module 3, a memory device 4, an output unit 6 and an input unit 7. The input unit 7, such as a keyboard, a joystick, a touch pad or the like, is used to control device. While downloading the digital content, the wireless communication module 2 is activated and the antenna module 3 coupled with is used to connect a network, by which the digital content is retrieved. Thus the digital content is retrieved through the antenna module 3 and the wireless communication module 2, such as RF (Radio Frequency) circuit. The digital packets retrieved from the server 11 are to be useful digital signals through packet processing in processor 1. Moreover, the data/packet under processing can be saved beforehand in the memory device 4, which is a temporary buffer. While the processor 1 processing the retrieved data, the data can be encrypted or the authentication information therein is determined.

Afterward, an IP header of the above mentioned packet needs to be re-calculated; for example, the IP header of the retrieved packet will be extracted, then the remaining packet is re-combined as a new packet, which is data-decoded and authenticated. After that, the re-combined data is temporarily saved into the memory device 4. The memory device 4 of the present invention is a buffer memory with limited volume, and the buffer memory can be implemented as a volatile or a non-volatile memory, such as a DRAM or a flash memory, where the mentioned digital content is stored temporarily. Next, the processor 1 proceeds to decode and decompress the digital signals from the digital content, and the content is output by a output unit 6, such as images/video output via a liquid crystal displayer (LCD), sound output via a speaker, or content in another format output via a specific program.

Furthermore, since the wireless communication module 2 is activated in the beginning, the aforementioned digital content saved in the memory device 4 is transmitted from the server connecting with Internet in a streaming format. Simultaneously, the content is decoded and decompressed by the processor 1, and output via the output unit 6. As the memory volume occupied by the content reaches a certain ratio, the process of transmission terminates and the wireless communication module 2 therein is de-activated. Meanwhile, the content saved in the memory device 4 still outputs via the output unit 6. Since the temporary content saved to the memory device 4 consumes and the remain data reaches an other certain ratio, the wireless communication module 2 is re-activated to download the digital content. By repeating the above steps of the method of the preferred embodiment, the implementation of real-time digital content transmission is met.

In the preferred embodiment of the present invention, for determining whether the connection between the server and the digital content device is established or not, the method for monitoring of the usage status of the memory device 4 is introduced. When the connection therebetween is down, the wireless communication module 2 is de-activated for power conservation.

The method for digital content transmission of the present invention is to monitor a memory device so as to determine the connection status of the digital content transmission, and is described in the following.

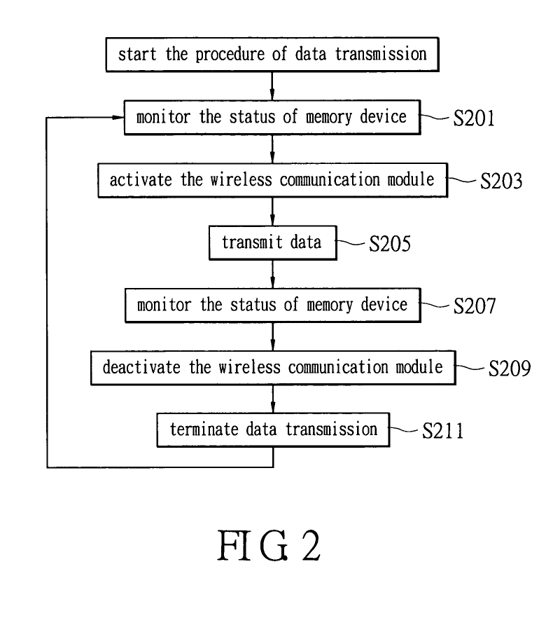

After the digital content device is switched on, the components of the device, such as a processor, a wireless communication module and an input/output unit, are initialized. After that, the steps for transmitting the digital content shown in FIG. 2 are conducted.

In the beginning, the processor built in the device monitors the usage status of the memory device (step S201). If the monitoring process proceeds when the device just starts, the process can be the initialization of the memory device. If the monitoring process proceeds during the operation of the digital content device, the process is to monitor the usage status of the memory device.

If the memory volume is lower than a first given ratio after the monitoring process, the wireless communication module coupling to the processor is activated (step S203). The wireless communication module, such as WiFi, WiMax, GPRS module, connects to a remote server over the network through an antenna module, then the server starts to transmit the digital data, which is stored in the digital content database coupling to the server (step S205).

During the transmission of the digital content, the processor of the digital content device consumes the data saved in the memory device. In the meantime, the usage status of the memory device is monitored by the processor (step S207). If the memory volume occupied with the digital content equals or exceeds a second given ratio, the wireless communication module is de-activated (step S209), and the connection between the digital content device and the server is down so as to turn the transmission off (step S211).

Afterward, by repeating the steps S201 to S211 as the digital content device operates, the method for digital content transmission for effective power saving is introduced.

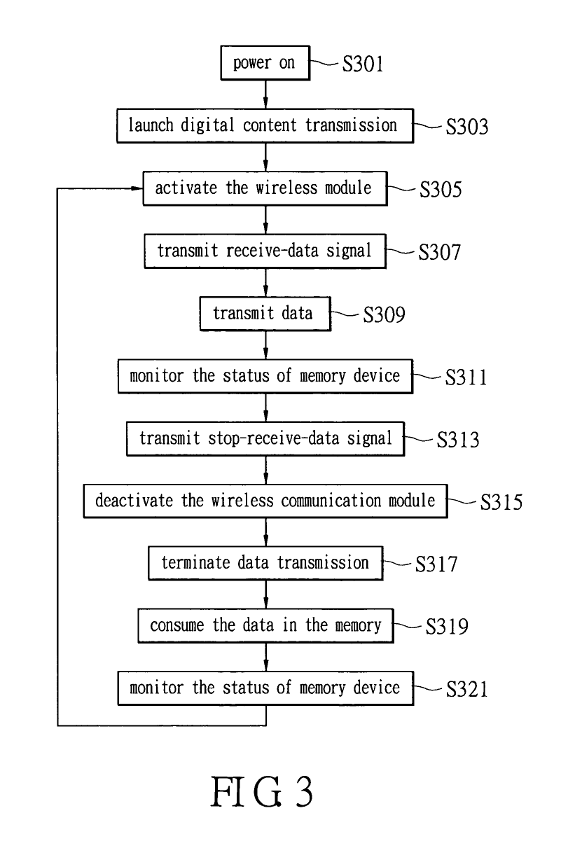

Reference is made to FIG. 3, which illustrates the steps for digital content transmission of the preferred embodiment of the present invention, and is described in the following.

After turning on the digital content device, the components thereof are initialized (step S301). The digital content transmission is launched after the initialization (step S303). In an illustrative implementation, the digital content including the compressed music and video is downloaded in a streaming format, so less memory is required.

After launching the transmission, the wireless module is activated (step S305), and the antenna module is turned on to connect to a remote server. In particular, the wireless communication module is de-activated in response to the transmission not being launched.

A receive-data signal is transmitted to the server stored with the digital content, since the memory device therein has no saved data in the initial state, or the memory volume occupied by the downloaded data consumes and reaches the first given ratio (step S307). Then the digital content device starts to retrieve the data from the server (step S309). The receive-data signal is transmitted by employing a specific communication protocol between a server and the wireless communication module.

The data saved in the memory device is consumed while transmitting the digital content. The user can listen to and watch the audio/video content downloaded in a streaming manner. The processor is used to monitor the usage status of memory device so as to determine whether the digital content is transmitted (step S311). When the memory volume occupied by the data reaches the second given ratio, a stop-receive-data signal is transmitted to the server (step S313). Since the server receives the stop-receive-data signal, the transmission therebetween terminates. In particular, the information of the transmitted data should be tagged to use as subsequent continuous transmission. At present, the server sends an acknowledge signal to the wireless communication module so as to message the digital content device. Since the digital content device acknowledges the server to terminate the data transmission, the wireless communication module is de-activated (step S315). That is, the processor terminates the data transmission so as to save the power consuming of the wireless communication module (step S317).

During the process of data transmission or the time to terminate the transmission, the data saved in the memory device is consumed (step S319). Meanwhile, the processor monitors the usage status of the memory device so as to determine whether the wireless communication module is re-activated to transmit the digital content (step S321).

As the memory volume occupied by the data is consumed to the first given ratio, the steps S305 to S321, such as the step for re-activating the wireless communication module, the step for connecting, the step for data streaming, and the step for memory device detection, of the method for digital content transmission are repeated for effective power saving.

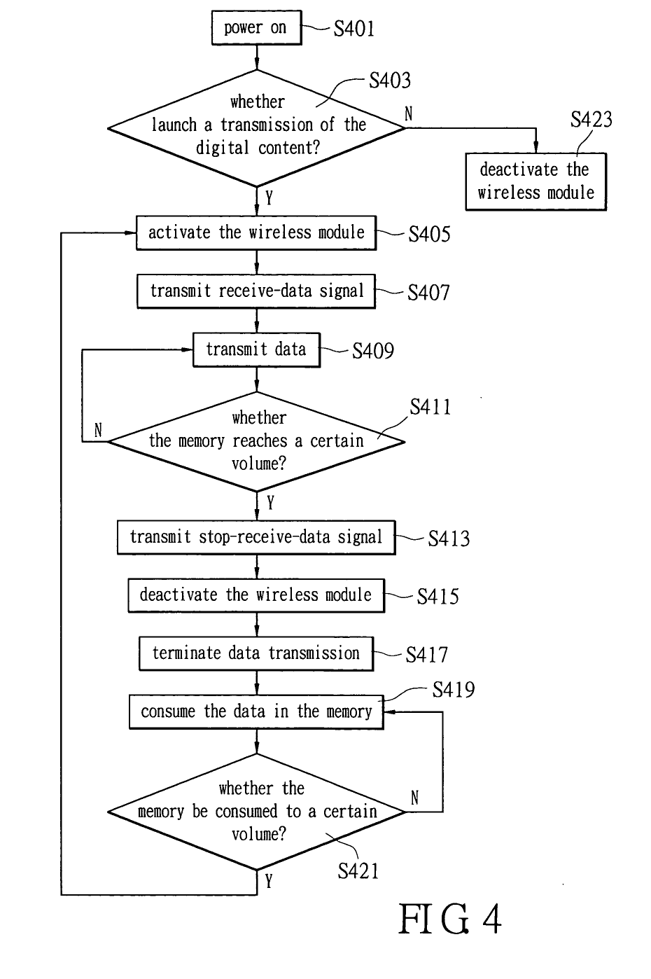

FIG. 4 shows the flowchart illustrating the method for digital content transmission of the preferred embodiment of the present invention.

In the beginning, the digital content device is turned on (step S401). The user can then decide whether the transmission of the digital content is launched (step S403). If the data transmission is not launched, the wireless communication module is de-activated (step S423). If the data transmission is launched, then the processor activates the wireless module (step S405). After that, the wireless communication module connects to the remote server via the antenna module coupled with. In particular, a receive-data signal is transmitted employing a specific communication protocol between a server and the wireless communication module (step S407). Furthermore, after the server receives the signal sent from the digital content device, the digital content device starts to transmit data (step S409).

The processor operates in the digital content device and determines whether the memory volume occupied by the saved data reaches a certain volume, such as the second given ratio mentioned above (step S411). If the occupied memory volume does not yet reach the certain preset ratio, step S409 introducing the data transmission proceeds. If the memory volume storing the data reaches the second given ratio, the stop-receive-data is transmitted to the server (step S413). Accordingly, after the server terminates the data transmission, the wireless communication module of the digital content device sends a stop-acknowledge signal adopting a specific communication protocol between the server and the digital content device. Afterwards, the device de-activates the wireless communication module (step S415) and stops transmitting/downloading data from the server (step S417).

During the data transmission, the user listens to or watches the digital content, such as audio or video, in the streaming format. When the memory volume occupied by the digital data reaches the second given ratio, the processor terminates the data transmission between the server and the device. Meanwhile, the data saved in the memory device consumes (step S419). The processor monitors whether the memory is consumed to a certain volume, such as the first given ratio during the time to terminate the transmission, and the data saved in the memory device is consumed (step S421). If the memory volume occupied does not reach the first given ratio, the digital content device is still in the process of consumption, as illustrated in step S419. If the memory volume is consumed to a certain ratio, the wireless communication module is re-activated to launch the data transmission as illustrated in step S405.

Moreover, steps S201 to S211 are repeated as the digital content device operates. If the memory volume reaches the second given ratio, the processor terminates the data transmission between the server and the device and de-activates the wireless communication module as well as for saving power consumption. If the occupied memory reaches the first given ratio, the processor activates the wireless communication module so as to connect to the server for data streaming.

The aforementioned first given ratio and the second given ratio are pre-defined ratio for memory usage. The method of the present invention will not interrupt the streaming data, so no lag will occur. The method for digital content transmission for effective power saving is introduced.

The many features and advantages of the present invention are apparent from the written description above and it is intended by the appended claims to cover all. Further, since numerous modifications and changes will readily occur to those skilled in the art, it is not desired to limit the invention to the exact construction and operation as illustrated and described. Hence, all suitable modifications and equivalents may be resorted to as falling within the scope of the invention.

What is claimed is:

1. A method for digital content transmission, for monitoring a memory device and determining a connection status of the digital content transmission, comprising:
monitoring a usage status of the memory device;
activating a wireless communication module;
transmitting a digital content;
monitoring the usage status of the memory device;
deactivating the wireless communication module; and
turning the digital content transmission off.

2. The method as recited in claim 1, wherein the usage status is monitored by a processor.

3. The method as recited in claim 1, wherein if a data size of the memory device is less than or equal to a first given ratio, the wireless communication module is activated.

4. The method as recited in claim 1, wherein if a data size of the memory device reaches a second given ratio, the wireless communication module is deactivated.

5. The method as recited in claim 1, wherein an antenna module coupled with the wireless communication module connects to a server after activating the wireless communication module.

6. The method as recited in claim 1, wherein data saved in the memory device is consumed while transmitting the digital content.

7. The method as recited in claim 1, wherein the digital content is transmitted in streaming format.

8. A method for digital content transmission, comprising:
activating a wireless communication module;
transmitting a receive-data signal;
transmitting data;
monitoring a usage status of a memory device to determine whether to transmit data;
transmitting a stop-receive-data signal;
deactivating the wireless communication module;
turning transmission off;
consuming data in the memory device; and
monitoring the usage status of the memory device to determine whether to re-activate the wireless communication module.

9. The method as recited in claim 8, wherein the data is transmitted in streaming format.

10. The method as recited in claim 8, wherein an antenna module coupled with the wireless communication module connects to a server after the wireless communication module is activated.

11. The method as recited in claim 8, wherein the usage status of the memory device is monitored by employing a processor.

12. The method as recited in claim 8, wherein the wireless communication module is activated when a volume of the memory device is less than or equal to a first given ratio.

13. The method as recited in claim 8, wherein the stop-receive-data signal is transmitted and the wireless communication module is deactivated when a volume of the memory device reaches a second given ratio.

14. The method as recited in claim 8, wherein the data saved in the memory device is consumed while transmitting the digital content.

15. The method as recited in claim 8, wherein the receive-data signal and the stop-receive-data signal are transmitted by employing a communication protocol between a server and the wireless communication module.

16. The method as recited in claim 8, wherein after the stop-receive-data signal is transmitted to a server, the wireless communication module is deactivated while the server sends a acknowledge signal.
